(19) United States
(12) Patent Application Publication
(10) Pub. No.: US 2025/0016883 A1
(43) Pub. Date: Jan. 9, 2025

(54) ENHANCEMENT TO A GTP-U ENTITY RESTART

(71) Applicant: Telefonaktiebolaget LM Ericsson (publ), Stockholm (SE)

(72) Inventors: Yong Yang, Kållered (SE); Erik Wikström, Göteborg (SE); Tony Olsson, Nösund (SE)

(21) Appl. No.: 18/707,683

(22) PCT Filed: Nov. 3, 2022
(86) PCT No.: PCT/EP2022/080624

§ 371 Date: May 6, 2024

Related U.S. Application Data
(60) Provisional application No. 63/276,035, filed on Nov. 5, 2021.

(51) Int. Cl. H04W 76/32; H04W 80/10

(52) U.S. Cl. CPC H04W 76/32; H04W 80/10

(57) ABSTRACT

Disclosed herein is a method performed by a Control Plane function 800, in a telecommunication network 1302 to manage a restart of a User Plane, UP, function in a user plane path for Protocol Data Unit, PDU, sessions that the CP function 800 is managing, the method comprises: receiving 900 a Packet Forwarding Control Protocol, PFCP, message from the UP function 802 comprising a report related to the UP-2 (804) has restarted; acknowledging 902 the report; and performing 904 an action based on an identity of the other UP-2 804.

### BACKGROUND

About 20 years ago, 3GPP has decided to remove the usage of Recovery from the General Packet Radio Service (GRPS) Tunnelling Protocol (GTP) Echo Response message for user plane (GTP-U), where the Recovery is defined as the restart counter for a GTP entity. Since, at that time, a GTP entity comprises a Control Plane (CP) part and User Plane (UP) parts, it is redundant to communicate the restart counter for a GTP entity via both the control plane signalling path and user plane payload path.

The usage of the “Restart counter” field in the “Recovery” information element in GTP-U messages was changed in March 2000 through 3GPP TS 29.060 Rel-3 CR 096, which was written on 3GPP TS 29.060 V3.4.0 and was implemented in 3GPP TS 29.060 V3.5.0. The “Reason for change” in the CR (3GPP TS 29.060 Rel-3 CR 096) reads as follows: “Restart counter in the Echo response message is used to inform the peer node that a node has experienced a restart. It is unnecessary to use the Restart counter value in both GTP-U and GTP-C, since it is sufficient to use it only in GTP-C. Moreover, at Iu interface RANAP already has a procedure for node restarts.

Therefore, it is proposed that the Restart counter value in the Echo Response message is not used in GTP-U. The CR also proposes some clarifications how to react when Echo response is received.”

Before 3GPP Rel-8, the normative specification of GTP-U was included together with GTPv1 in 3GPP TS 29.060. In 3GPP Rel-8, the normative specification of GTP-U was moved from 3GPP TS 29.060 to 3GPP TS 29.281. The text on GTP-U was, in fact, left “as was” in 3GPP TS 29.060 and a note was added at the beginning of clause 9 in the specification. The note reads as follows: “From release 8 onwards, the normative specification of the user plane of GTP version 1 is 3GPP TS 29.281 [41]. All provisions about GTPv1 user plane in the present document shall be superseded by 3GPP TS 29.281 [41].”

So as specified in TS 29.281, clause 7.2.2 states: “The Restart Counter value in the Recovery information element shall not be used, i.e. it shall be set to zero by the sender and shall be ignored by the receiver. The Recovery information element is mandatory due to backwards compatibility reasons. The optional Private Extension contains vendor or operator specific information.” (Emphasis added).

### FIG. 1

FIG. 1 of the present disclosure includes Table 7.2.2.-1 of the clause 7.2.2 of TS 29.281.

Further, clause 7.7.114 (“ULI Timestamp”) of TS 29.281 discloses, “The ULI Timestamp IE is coded as shown in FIG. 7.7.114-1. It indicates the UTC time when the user location information was acquired. Octets 4 to 7 are encoded in the same format as the first four octets of the 64-bit timestamp format as defined in clause 6 of IETF RFC 5905 [55]. NOTE: The encoding is defined as the time in seconds relative to 00:00:00 on 1 Jan. 1900.”

### FIG. 2

FIG. 2 of the present disclosure includes the figure (“FIG. 7.7.114-1: ULI Timestamp”) in clause 7.7.114 of TS 29.281.

Consequently, 3GPP does not specify any requirement on the peer GTP-u restart, but only GTP-U path failure. For example, as stated in, in TS 23.527 for Fifth Generation System (5GS):

### Start of TS 23.527, Clause 5.4

### 5.4 Restoration Procedures Upon User Plane Path Failure

Upon detecting a GTP-U user plane path failure as specified in clause 5.2.2, the UPF shall report the user plane path failure to the SMF, by sending a PFCP Node Report Request (see 3GPP TS 29.244 [4]) including a User Plane Path Failure Report with the IP address of the remote GTP-U peer(s) towards which a failure has been detected. The UPF should also notify the GTP-U user plane path failure via the Operation and Maintenance system.
When the SMF receives the PFCP Node Report Request with a User Plane Path Failure Report, the SMF may:
   delete the PDU session contexts associated with the path in failure: or
   maintain the PDU session contexts associated with the path in failure during an operator configurable maximum path failure duration. The SMF shall delete the PDU session contexts associated with the path in failure if the path is still down when this duration expires.
   NOTE 1: During transient path failures (e.g. path failures not exceeding few minutes at most), maintaining the PDU session contexts associated with the peer's IP address enables the delivery of end user services (when the path is re-established again) and this also avoids unnecessary signalling in the network for restoring those PDU sessions.
   NOTE 2: It is not intended to maintain PDU session contexts during long path failures (e.g. exceeding few minutes at most) as this would imply undesirable effects like undue charging.
When deciding to delete the PDU session contexts associated with the path in failure, the SMF shall modify or delete the affected PFCP sessions in the UPF.
   NOTE 3: The SMF need to take care to smoothen the signalling load towards the UPF if a large number of PFCP sessions are affected by the user plane path failure.

### End of TS 23.527, Clause 5.4

And in TS 23.007 for EPS, clause 20.3 discloses:

### Start of TS 23.007, Clause 20.3

### 20.3 User Plane Path Failure Detection and Handling

### 20.3.1 General

GTP-U entities shall support detection of path failure by using Echo Request/Echo Response messages in the following way. A path counter shall be reset each time an Echo Response is received on the path and incremented when the T3-RESPONSE timer expires for any Echo Request message sent on the path. The path shall be considered to be down if the counter exceeds N3-REQUESTS.
Upon detecting a path failure, the network node should notify the failure via the Operation and Maintenance system and may either
   delete the bearer contexts associated with the path in failure: or
   maintain the bearer contexts associated with the path in failure during an operator configurable maximum path failure duration. The network node shall delete the maintained resources if the path is still down when this duration expires.

### End of TS 23.007, Clause 20.3

When a GTP-U entity receives a GTP-U packets without corresponding context, it will send a GTP error indication. Clause 7.3.1 of TS 29.281 discloses:

### Start of TS 29.281, Clause 7.3.1

### 7.3.1 Error Indication

When a GTP-U node receives a G-PDU for which no EPS Bearer context, PDP context, PDU Session, MBMS Bearer context, or RAB exists, the GTP-U node shall discard the G-PDU. If the TEID of the incoming G-PDU is different from the value ‘all zeros’ the GTP-U node shall also return a GTP error indication to the originating node. GTP entities may include the “UDP Port” extension header (Type 0x40), in order to simplify the implementation of mechanisms that can mitigate the risk of Denial-of-Service attacks in some scenarios.
Handling of the received Error Indication is specified in 3GPP TS 23.007 [3] and 3GPP TS 23.527 [33].
The information element Tunnel Endpoint Identifier Data I shall be the TEID fetched from the G-PDU that triggered this procedure.
The information element GTP-U Peer Address shall be the destination address (e.g. destination IP address. MBMS Bearer Context) fetched from the original user data message that triggered this procedure. A GTP-U Peer Address can be a GGSN, SGSN, RNC, PGW, SGW, ePDG, eNodeB, TWAN, MME, gNB, N3IWF, or UPF address. The TEID and GTP-U peer Address together uniquely identify the related PDP context. RAB. PDU session or EPS bearer in the receiving node.
The optional Private Extension contains vendor or operator specific information.

### End of TS 29.281. Clause 7.3.1

### FIG. 3

FIG. 3 of the present disclosure includes a table of TS 29.281, clause 7.3.1 (“Table 7.3.1-1: Information Elements in an Error Indication”).

Once the peer GTP-U entity has received a GTP Error Indication, which indicates the user plane path for a given Packet Data Network (PDN) connection/Protocol Data Unit (PDU) session is broken, this has to be reported to control plane function, e.g. Serving Gateway Control plane function (SGW-C), or PDN Gateway Control plane function (PGW-C), or Session Management Function (SMF), so that the control plane function may trigger relevant control plane signalling procedure to request restarted GTP-U entity (e.g. a New Generation Radio Access Network (NG-RAN)) to setup the user plane for that PDN connection.

### FIG. 4

FIG. 4 includes a figure (“FIG. 5.3.2.1-1: GTP-U Error Indication from 5G-AN”) in clause 5.3.2 (“Procedure for GTP-U Error Indication received from 5G-AN”) of TS 23.527. Regarding the figure (“FIG. 5.3.2.1-1: GTP-U Error Indication from 5G-AN”), clause 5.3.2 of TS 23.527 further discloses:

### Start of TS 23.527. Clause 5.3.2

1. The user plane connection of an existing PDU session is activated. Downlink G-PDUs are sent towards the 5G-AN.
2. The 5G-AN returns a GTP-U Error Indication if it does not have a corresponding GTP-U context (see clause 5.2).
3. Upon receipt of a GTP-U Error Indication, the UPF shall identify the related PFCP session and send an Error Indication Report to the SMF, as specified in clause 5.10 of 3GPP TS 29.244 [4].
4. For a GTP-U Error Indication received from a 5G-AN, the SMF shall modify the PFCP session to instruct the UPF to buffer downlink packets.
5. If the user plane connection of the PDU session is seen as activated by the SMF, the SMF shall initiate an Namf_Communication_NIN2MessageTransfer service operation to request the 5G-AN to release the PDU session's resources, as specified in clause 4.3.7 of 3GPP TS 23.502 [5].
6. Upon receipt of an Namf_Communication_NIN2MessageTransfer request to transfer the PDU Session Resource Release Command, the AMF shall:
   proceed with the request, as specified in clause 5.2.2.3.1 of 3GPP TS 29.518 [6], if the UE is in CM-CONNECTED state for the Access Network Type associated to the PDU session;
   otherwise. reject the request with an error indicating that the UE is in CM-IDLE state for the Access Network Type associated to the PDU session.
7. If the AMF sent a PDU Session Resource Release Command to the 5G-AN, the PDU session's resource release is acknowledged to the SMF.
8. The SMF initiates the Network Triggered Service Request procedure specified in clause 4.2.3.3 of 3GPP TS 23.502 [5], to re-activate the user plane connection of the PDU session.

### End of TS 23.527. Clause 5.3.2

In TS 29.244, clause 7.4.5.1.1 (“PFCP Node Report Request—General”) discloses, “The PFCP Node Report Request shall be sent over the Sxa, Sxb, Sxc and N4 interface by the UP function to report information to the CP function that is not specific to a PFCP session.”

### FIG. 5

FIG. 5 of the present disclosure includes a table (“Table 7.4.5.1.1-1: Information Elements in PFCP Node Report Request”) in clause 7.4.5.1.1 of TS 29.244.

### FIG. 6

FIG. 6 of the present disclosure includes a table (“Table 7.4.5.1.2-1: User Plane Path Failure Report IE within PFCP Node Report Request”) of clause 7.4.5.1.2 (“User Plane Path Failure Report IE within PFCP Node Report Request”) of TS 29.244.

### FIG. 7

FIG. 7 of the present disclosure includes a figure (“FIG. 8.2.70-1: Remote GTP-U Peer”) in clause 8.2.70 (“Remote GTP-U Peer”) of TS 29.244.

### SUMMARY

There currently exist certain challenge(s). In the event of a GTP-U entity restart, for example, a NG-RAN (e.g., a gNB) has restarted, it will lose all its contexts, therefore it is not possible to find corresponding contexts for the DL GTP-U packets from Intermediate User Plane Function (I-UPF) or Visiting UPF (V-UPF). This triggers the restarted GTP-U entity to send massive amounts of GTP error indication messages, which, in turn, leads to massive amounts of signalling over Sx/N4 interface since the UP function has to report the receiving of GTP error indication to the CP function.

When a GTP-U entity has restarted, such massive signalling over GTP-U interface (for sending GTP error indication) and over Sx/N4 (reporting the receiving of GTP error indication and Packet Forwarding Control Protocol (PFCP) session modification signalling to update DL FAR) should be avoided.

Certain aspects of the disclosure and their embodiments may provide solutions to these or other challenges. The present disclosure proposes embodiments for enabling a GTP-U entity (e.g., for SGW-U, PGW-U, or UPF) to detect that the peer GTP-U entity has restarted and if so, to report the restart of the peer GTP-U entity to the CP function (e.g., SGW-C, PGW-C, SMF), so that CP function can restore the user plane path.

The embodiments of the present disclosure include one or more of the following features:
1. Add recovery timestamp in Echo Response message. The recovery timestamp may reuse GTPv1 IE “ULI Timestamp” or a new IE with same encoding as in “ULI Timestamp” IE.
2. Add recovery timestamp in GTP error indication to populate the restart to the peer GTP-U entity as soon as possible. Some GTP-U entity implementation may not send an Echo request/response when there are payload packets transferring. In this case, the user plane path may be considered as healthy.
3. Add a list of IP address (affected by the restart) in the GTP error indication since a User Plane function (UP function) may have multiple GTP-U entities which is identified by “IP address.”
4. When the UP function detects the peer GTP-U has restarted, the UP function will send a “PFCP Node Report Request” message to the CP function. The PFCP Node Report Request message contains the information that the peer GTP-U entity has restarted together with a list of IP addresses, and Network Instance/Destination interface. In addition, the UP function indicates that the UP function is about to remove the remote Fully qualified Tunnel Endpoint Identifier (F-TEID) and set Apply-Action to “buffering” in the FAR (containing the remote F-TEID which was allocated by the remote GTP-U entity and thus it has been affected by the remote GTP-U restart) for all PFCP sessions affected by peer GTP-u restart, so that the CP function does not need to send a “PFCP Session Modification Request” per a PFCP session to do this (e.g., the CP function removes the remote F-TEID in the FAR and change apply-action).
5. The CP function acknowledges the report that the peer GTP-U entity has restarted, the F-TEID allocated by the restarted GTP-U entity becomes invalid and should be removed from affected PFCP sessions.
6. The CP function decide to release the PDU sessions which affected by the remote GTP-U restart based on local configuration, e.g. to release the affected PDU sessions if the restarted remote GTP-U entity is a PDU Session Anchor (PSA) UPF; or to restore the user plane connection for affected PDU sessions, e.g., if the restarted remote GTP-U entity is a NG-RAN (e.g., gNB) or RAN (e.g., eNB).

Certain embodiments may provide one or more of the following technical advantage(s). Massive signalling for a GTP-U entity restart may be avoided where the GTP-U has lost all its GTP-U contexts and those GTP-U contexts cannot be restored by other means, e.g., via its CP function.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 includes Table 7.2.2.-1 of clause 7.2.2 in TS 29.281;

FIG. 2 includes the figure (“FIG. 7.7.114-1: ULI Timestamp”) in clause 7.7.114 of TS 29.281;

FIG. 3 includes a table of TS 29.281, clause 7.3.1 (“Table 7.3.1-1: Information Elements in an Error Indication”);

FIG. 4 includes a figure (“FIG. 5.3.2.1-1: GTP-U Error Indication from 5G-AN”) in clause 5.3.2 (“Procedure for GTP-U Error Indication received from 5G-AN”) of TS 23.527;

FIG. 5 includes a table (“Table 7.4.5.1.1-1: Information Elements in PFCP Node Report Request”) in clause 7.4.5.1.1 of TS 29.244;

FIG. 6 includes a table (“Table 7.4.5.1.2-1: User Plane Path Failure Report IE within PFCP Node Report Request”) of clause 7.4.5.1.2 (“User Plane Path Failure Report IE within PFCP Node Report Request”) of TS 29.244;

FIG. 7 includes a figure (“FIG. 8.2.70-1: Remote GTP-U Peer”) in clause 8.2.70 (“Remote GTP-U Peer”) of TS 29.244;

FIG. 8 illustrates one embodiment of a procedure for detecting and reporting a peer GTP-U entity restart, in accordance with one example embodiment of the present disclosure;

FIG. 9 illustrates one embodiment wherein the CP-1 800 may perform a number of steps;

FIG. 10 illustrates one embodiment wherein the UP-1 802 may perform a number of steps;

FIG. 11 illustrates one embodiment wherein the UP-2 804 may perform a number of steps;

FIG. 12 illustrates one embodiment wherein the CP-1 800 may perform a number of steps;

FIG. 13 illustrates one example of a cellular communications system 1300 in which embodiments of the present disclosure may be implemented;

FIG. 14 illustrates a wireless communication system represented as a 5G network architecture composed of core Network Functions (NFs), where interaction between any two NFs is represented by a point-to-point reference point/interface;

FIG. 15 illustrates a 5G network architecture using service-based interfaces between the NFs in the CP, instead of the point-to-point reference points/interfaces used in the 5G network architecture of FIG. 14;

FIG. 16 is a schematic block diagram of a network node 1600 according to some embodiments of the present disclosure;

FIG. 17 is a schematic block diagram that illustrates a virtualized embodiment of the network node 1600 according to some embodiments of the present disclosure;

FIG. 18 is schematic block diagram of the network node 1600 according to some other embodiments of the present disclosure.

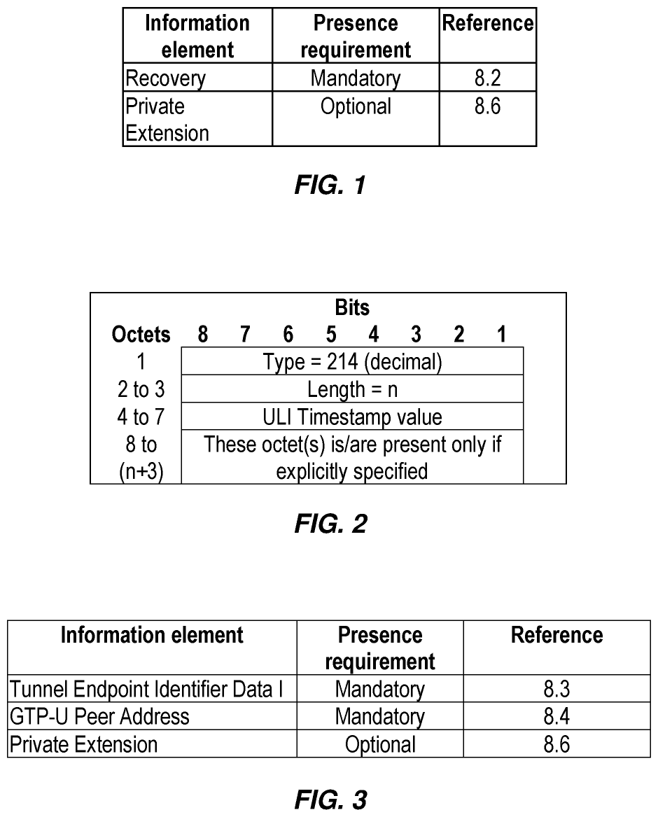

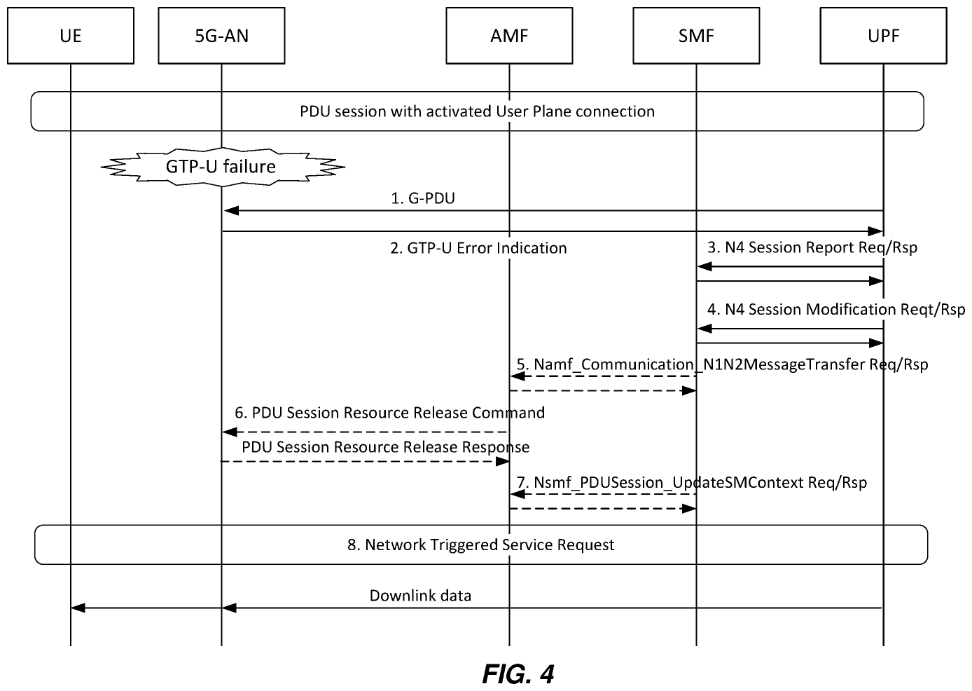

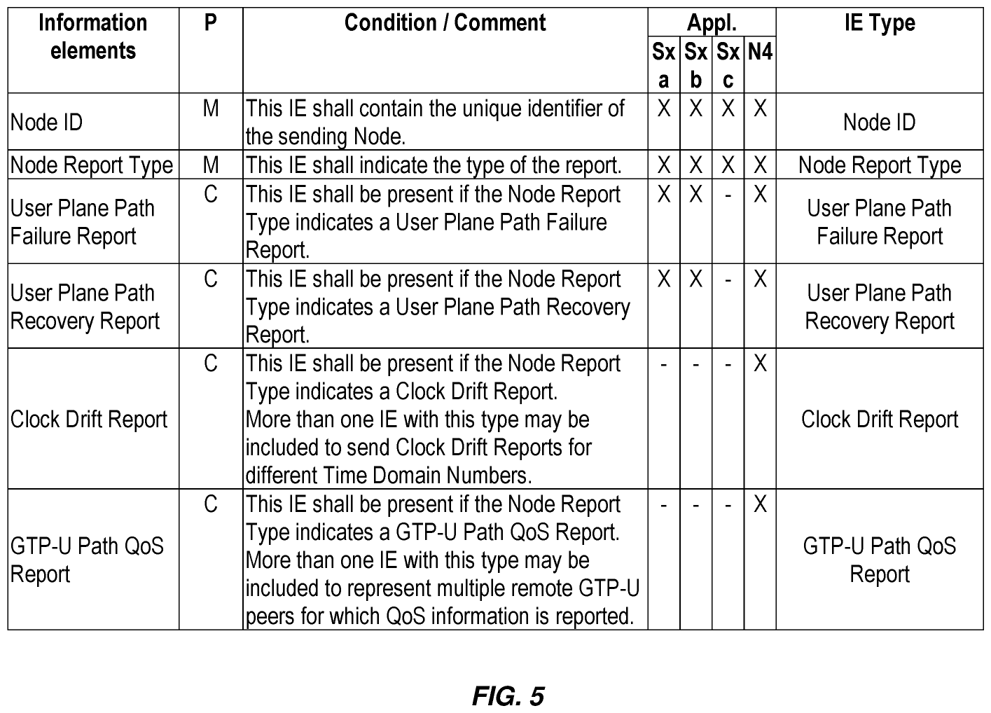

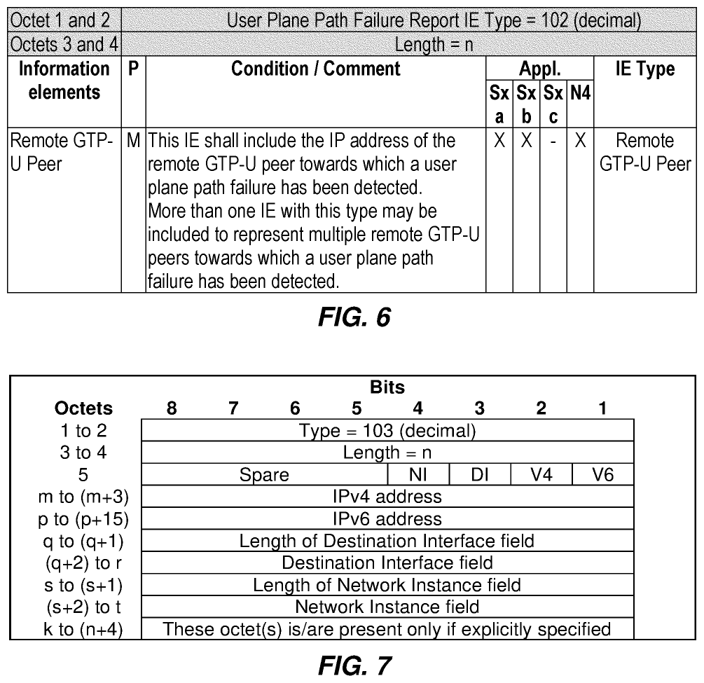

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the document(s) provided in the Appendices (Appendix 1 and Appendix 2).

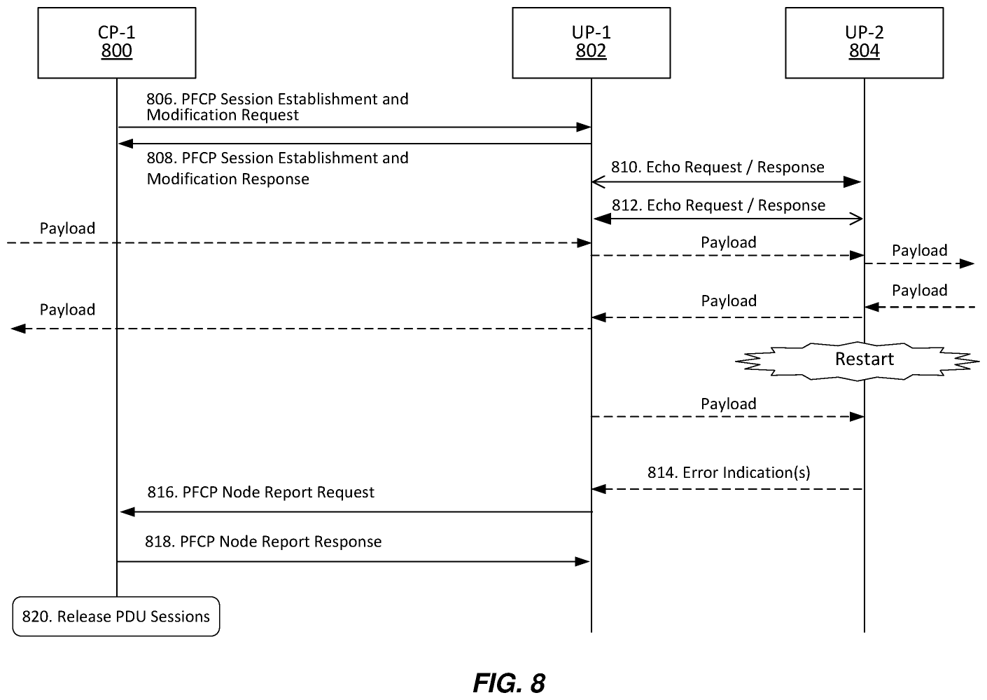

### FIG. 8

FIG. 8 illustrates one embodiment of a procedure for detecting and reporting a peer GTP-U entity restart, in accordance with one example embodiment of the present disclosure. The procedure is performed by a CP function (“CP-1 800”), a first UP function (“UP-1 802”), and a second UP function (“UP-2 804”). The CP-1 800 may be or be implemented in SGW-C, PGW-C, or SMF. The UP-1 802 or the UP-2 804 may be or be implemented in gNB, eNB, SGW-U, PGW-U, I-UPF (Intermediate UPF), or V-UPF (Visiting UPF). FIG. 8 of the present disclosure illustrates the following steps.

In step 806 and step 808, PFCP Session Establishment and Modification Request/Response messages are used to setup PFCP session between the CP-1 800 and the UP-1 802. The procedure enables the CP-1 800 to provide a remote GTP-U's (the UP-2 804) F-TEID (IP address+Tunnel Endpoint ID) to the UP-1 802. In other words, the PFCP Session Establishment and Modification Request message may contain the remote GTP-U's F-TEID. Thus, the UP-1 802 will send the payload towards and, at the same time, the UP-1 802 will provide its GTP-U F-TEID (that is used to receive a payload from the remote GTP-U (the UP-2 804) to the CP function. The CP function will further use control plane signalling to populate the UP-1's GTP-U F-TEID to the UP-2 804, e.g. via NGAP signalling message (a PDU Session Resource Setup Request message if the UP-2 804 is a NG-RAN node).

In step 810 and step 812, the UP-1 802 may send an “Echo Request” to the UP-2 804, which includes the IP address (in the F-TEID from the UP-2 804) to probe the liveness of the UP-2 804. The Echo Request comprises Recovery Information of the UP-1 802, which is identified by the source IP address of the Echo Request. The UP2 will reply with an “Echo Response” message that contains its Recovery Information, which is identified by the resource IP address of the Echo Response. The UP-1 802 will store the UP-2's Recovery Information for future comparison.

The UP-2 804 may send an “Echo Request” to the UP-1 802 as well. Then, the UP-2 2 804 may receive an “Echo Response” from the UP-1 802 as well. A payload is transferring end to end, including the segment between the UP-1 802 and the UP-2 804. The UP-2 804 has restarted and recovered from the restart. However, the UP-2 804 has lost all its GTP-U contexts, i.e. it cannot recognize the F-TEIDs it allocated before its restart.

In step 814, when the restarted UP-2 804 receives a payload addressing a GTP-U F-TEID which it does not recognize, the restarted UP-2 804 sends (1) a “GTP Error Indication” message, which contains a changed Recovery Information, and (2) a list of IP address affected by the restart, i.e. all GTP-U context associated with these IP addresses have been lost.

In step 816, the UP-1 802 sends a “PFCP Node Report Request” message to the CP-1 800, which indicates that (1) the peer UP (the UP-2 804) has restarted, and GTP-U context associated with a list of IP addresses (provided in GTP Error Indication) have been lost; and (2) the UP-1 802 is to set apply-action in DL FAR to “buffering” and remove DL F-TEID (from the UP-2 804), for all affected PFCP sessions, i.e. the CP-1 800 needs not to send a “PFCP Session Modification Request” message to change DL FAR per a PFCP session.

In step 818, as a response to the PFCP Node Report Request message, the CP-1 800 sends, to the UP-1 802, a “PFCP Node Report Response” comprising an acknowledgment that the Downlink FAR in all affected PFCP sessions (with the restarted UP-2 804) has been updated with apply-action set to “buffering,” and remote F-TEID (from the UP-2 804) is removed.

In step 820, the CP-1 800 decides to release the PDU sessions affected by the remote GTP-U restart based on a local configuration, e.g. to release the affected PDU sessions if the restarted remote GTP-U entity is a PSA UPF; or to restore the user plane connection for affected PDU sessions, e.g. if the restarted remote GTP-U entity is a NG-RAN (e.g., gNB) or RAN (e.g., eNB).

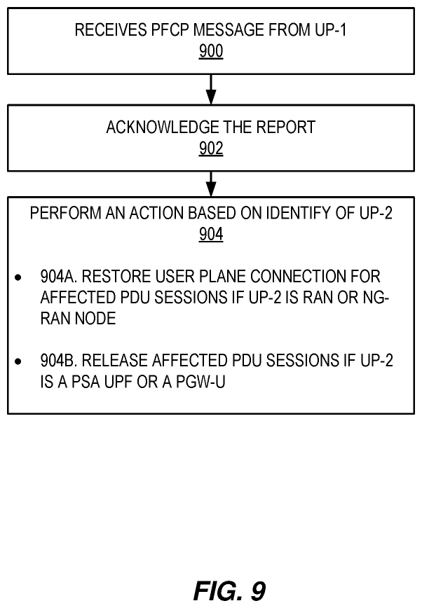

### FIG. 9

In one embodiment, the CP-1 800 may perform the following steps illustrated in FIG. 9.

In step 900, the CP-1 800 receives a PFCP message, from the UP-1 802, containing a report related to the UP-2 804 has restarted. Optionally, the PFCP message is a PFCP Node Report Request message. Optionally, the report further comprises an indication that the UP-1 802 has removed remote F-TEID(s) allocated by the UP-2 804 and changed apply-action in FAR to “buffering” for all affected PFCP sessions.

In step 902, the CP-1 800 acknowledges the report, i.e. the CP-1 800 will not send a PFCP session modification request message to remove the remote F-TEID and change Apply-action in FAR to the UP-1 802.

In step 904, the CP-1 800 performs an action based on an identity of the UP-2 804. In step 904A, the CP-1 800 restores a user plane connection for affected PDU sessions if the UP-2 804 is RAN or NG-RAN node. In step 904B, the CP-1 800 releasing the affected PDU sessions if the UP-2 804 is a PSA UPF or a PGW-U.

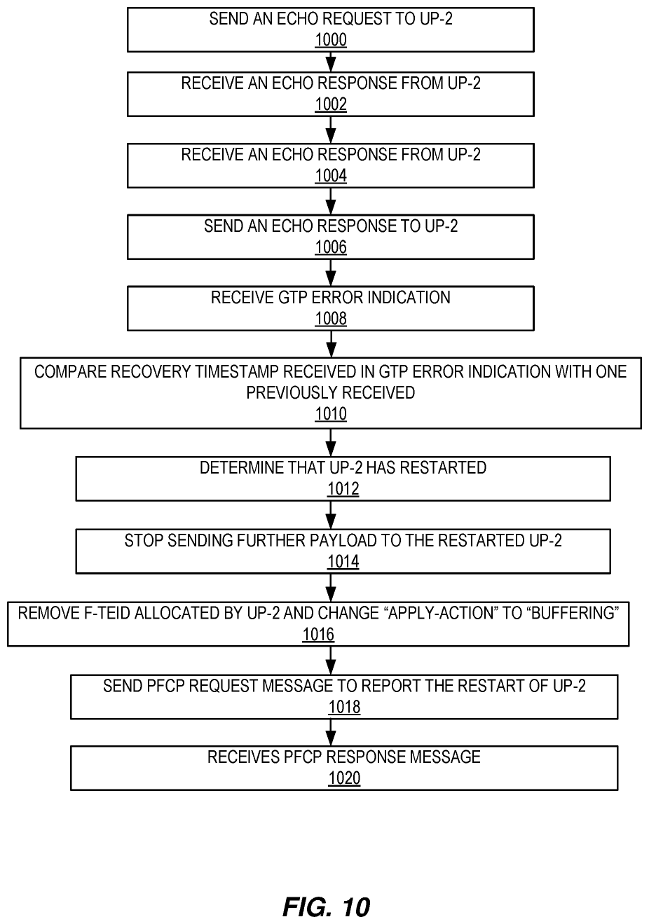

### FIG. 10

In one embodiment, the UP-1 802 may perform the following steps illustrated in FIG. 10.

In step 1000, the UP-1 802 sends an Echo Request to the UP-2 804. Optionally, the Echo Request may comprise recovery timestamp.

In step 1002, the UP-1 802 receives an Echo Response from the UP-2 804.

In step 1004, the UP-1 802 receives an Echo Request from the UP-2 804.

In step 1006, the UP-1 802 sends an Echo Response to the UP-2 804. Up to this step, the UP-1 802 and the UP-2 804 have exchanged their recovery timestamps, so they will know any F-TEID allocated before a new recovery timestamp (due to a restart) become invalid. The above steps 1000 to 1006 are example steps of exchanging the Echo Requests/the Echo Responses between the UP-1 802 and UP-2 804. Thus, the time order of the steps 1000 to 1006 can be varied. For example, the steps 1004 and 1006 may occur before the steps 1000 and 1002.

In step 1008, the UP-1 802 receives a GTP error indication comprising a recovery timestamp.

In step 1010, the UP-1 802 compares the recovery timestamp received in the GTP error indication with the one previously received via the Echo Request, the Echo Response, or the GTP error indication.

In step 1012, the UP-1 802 determines that the UP-2 804 has restarted.

In step 1014, the UP-1 802 stops sending further payload to the restarted UP-2 804, for example, to avoid receiving further GTP error indications, and over-charge UE/PDU sessions affected by the restart of the UP-2 804.

In step 1016, the UP-1 802 removes the F-TEID allocated by the UP-2 804 and change “apply-action” to “Buffering” because the UP-1 802 does not send payloads anymore.

In step 1018, the UP-1 802 sends a PFCP request message to report the restart of the UP-2 804. Optionally, the PFCP request message is PFCP node report request message.

In step 1020, the UP-1 802 receives a PFCP response message.

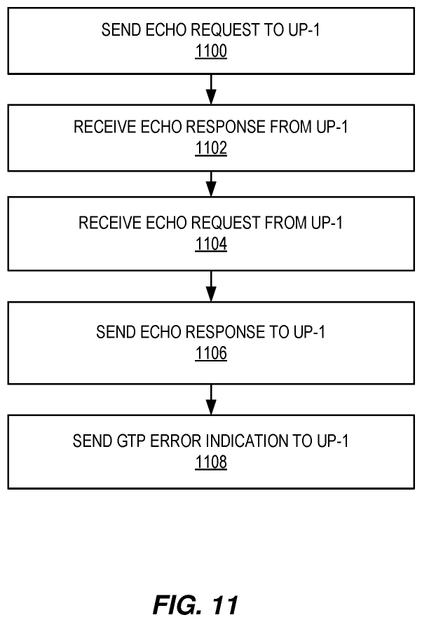

### FIG. 11

In one embodiment, the UP-2 804 may perform the following steps illustrated in FIG. 11.

In step 1100, the UP-2 804 sends an Echo Request to the UP-1 802. Optionally, the Echo Request comprises a recovery timestamp.

In step 1102, the UP-2 804 receives an Echo Response from the UP-1 802.

In step 1104, the UP-2 804 receives an Echo Request from the UP-1 802.

In step 1106, the UP-2 804 sends an Echo Response to the UP-1 802. Up to this step, the UP-1 802 and the UP-2 804 have exchanged their recovery timestamps, so they will know any F-TEID allocated before a new recovery timestamp (due to a restart) become invalid. The above steps 1100 to 1106 are example steps of exchanging the Echo Requests/the Echo Responses between the UP-1 802 and UP-2 804. Thus, the time order of the steps 1100 to 1106 can be varied. For example, the steps 1104 and 1106 may occur before the steps 1100 and 1102.

In step 1108, the UP-2 804 sends a GTP error indication comprising a new recovery timestamp to the UP-1 802.

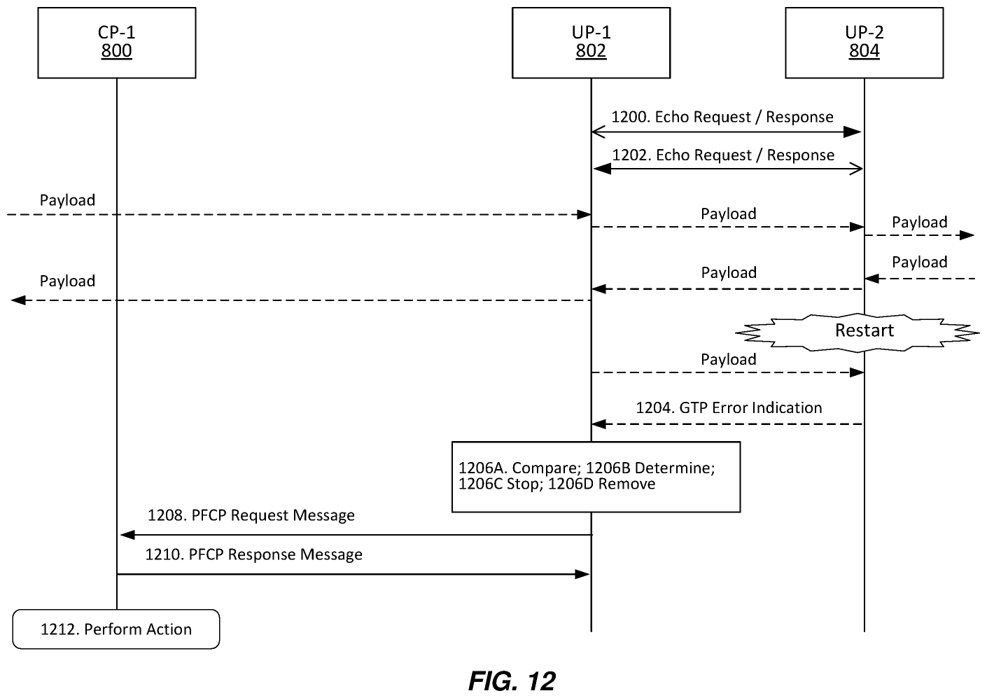

### FIG. 12

In one embodiment, the CP-1 800 may perform the following steps illustrated in FIG. 12.

In step 1208, the CP-1 800 receives a Packet Forwarding Control Protocol (PFCP) request message from the UP-1 802, which comprises a report related to the UP-2 804 has restarted.

In step 1210, the CP-1 800 acknowledges the report by sending a PFCP response message to the UP-1 802.

In step 1212, the CP-1 800 performs an action based on an identity of the UP-2 804. If the identity of the UP-2 804 is a RAN or a NG-RAN node, the action is restoring user plane connection for affected PDU sessions. If the identity of the UP-2 804 is a PSA UDF or a PGW-U, the action is releasing affected PDU sessions.

In one embodiment, the UP-1 802 may perform the following steps illustrated in FIG. 12.

In step 1200 and step 1202, the UP-1 802 exchanges Echo Requests and Echo Responses with the UP-2 804.

In step 1204, the UP-1 802 receives an GTP error indication containing a recovery timestamp;

In step 1206A, the UP-1 802 compares the recovery timestamp received in the GTP error indication with a recovery timestamp previously received via the Echo Request, the Echo Response or the GTP error indication.

In step 1206B, the UP-1 802 determines that the UP-2 804 has restarted.

In step 1206C, the UP-1 802 stops sending a further payload to the restarted UP-2 804.

In step 1206C, the UP-1 802 removes the F-TEID allocated by the UP-2 804 and change apply-action to Buffering.

In step 1208, the UP-1 802 sends the PFCP request message to report the restart of the UP-2 804.

In step 1210, the UP-1 802 receives the PFCP response message.

In one embodiment, the UP-2 804 may perform the following steps illustrated in FIG. 12.

In step 1200 and step 1202, the UP-2 804 exchanges Echo Requests and Echo Responses with the UP-1 802.

In step 1204, the UP-2 804 sends an GTP error indication comprising a new recovery timestamp.

### 3GPP Changes

The following exemplifies several 3GPP changes (in stage 3 specifications) to support the present disclosure. The texts (or Information Elements) in italicized bold font indicate newly suggested changes to the 3GPP standards.

The following clauses (7.2.2 and 7.3.1) of TS 29.281 are proposed to change in the portions indicated by the text (or Information Elements) in italicized bold font:

### Start of TS 29.281

### 7.2.2 Echo Response

The message shall be sent as a response to a received Echo Request.

The Restart Counter value in the Recovery information element shall not be used, i.e. it shall be set to zero by the sender and shall be ignored by the receiver. The Recovery information element is mandatory due to backwards compatibility reasons.

The optional Private Extension contains vendor or operator specific information.

TABLE 7.2.2-1
Information Elements in an Echo Response

| Information element | Presence requirement | Reference |
|---|---|---|
| Recovery | Mandatory | 8.2 |
| Recovery Timestamp | Optional | 8.x |
| Private Extension | Optional | 8.6 |

### 7.3.1 Error Indication

When a GTP-U node receives a G-PDU for which no EPS Bearer context, PDP context, PDU Session, MBMS Bearer context, or RAB exists, the GTP-U node shall discard the G-PDU. If the TEID of the incoming G-PDU is different from the value ‘all zeros’ the GTP-U node shall also return a GTP error indication to the originating node. GTP entities may include the “UDP Port” extension header (Type 0x40), in order to simplify the implementation of mechanisms that can mitigate the risk of Denial-of-Service attacks in some scenarios.

Handling of the received Error Indication is specified in 3GPP TS 23.007 [3] and 3GPP TS 23.527 [33]. The information element Tunnel Endpoint Identifier Data I shall be the TEID fetched from the G-PDU that triggered this procedure.

The information element GTP-U Peer Address shall be the destination address (e.g., destination IP address, MBMS Bearer Context) fetched from the original user data message that triggered this procedure. A GTP-U Peer Address can be a GGSN, SGSN, RNC, PGW, SGW, ePDG, eNodeB, TWAN, MME, gNB, N3IWF, or UPF address. The TEID and GTP-U peer Address together uniquely identify the related PDP context, RAB, PDU session or EPS bearer in the receiving node. The optional Private Extension contains vendor or operator specific information.

TABLE 7.3.1-1
Information Elements in an Error Indication

| Information element | Presence requirement | Reference |
|---|---|---|
| Tunnel Endpoint Identifier Data I | Mandatory | 8.3 |
| GTP-U Peer Address | Mandatory | 8.4 |
| Recovery Timestamp | Optional | 8.x |
| List of IP Addresses sharing the | Optional | 8.y |
| same Recovery Timestamp | | |
| Private Extension | Optional | 8.6 |

### End of TS 29.281

The following clauses of TS 29.244 are proposed to change in the portions indicated by the text (or Information Elements) in italicized bold font:

### Start of TS 29.244

### 7.4.5.1.1 General

The PFCP Node Report Request shall be sent over the Sxa, Sxb, Sxc and N4 interface by the UP function to report information to the CP function that is not specific to a PFCP session.

TABLE 7.4.5.1.1-1
Information Elements in PFCP Node Report Request

| | | | Appl. | | | | |
|---|---|---|---|---|---|---|---|
| Information | | | Sx | Sx | Sx | | |
| elements | P | Condition/Comment | a | b | c | N4 | IE Type |
| Node ID | M | This IE shall contain the unique identifier of the | X | X | X | X | Node ID |
| | | sending Node. | | | | | |
| Node Report Type | M | This IE shall indicate the type of the report. | X | X | X | X | Node Report Type |
| * | * | * | * | * | * | * | * |
| GTP-U Path | C | This IE shall be present if the Node Report Type | — | — | — | X | GTP-U Path |
| QoS Report | | indicates a GTP-U Path QoS Report. | | | | | QoS Report |
| | | More than one IE with this type may be included to | | | | | |
| | | represent multiple remote GTP-U peers for which | | | | | |
| | | QoS information is reported. | | | | | |
| Peer UP | C | This IE shall be present if the Node Report Type | X | X | — | X | Peer UP |
| Restart Report | | Indicates a remote GTP-U entity has restarted. | | | | | Restart Report |

7.4.5.1.X Peer UP Restart Report IE within PFCP Node Report Request

TABLE 7.4.5.1.X-1
User Plane Path Recovery Report IE within PFCP Node Report Request
Octet 1 and 2 User Plane Path Recovery Report IE Type = 187 (decimal)
Octets 3 and 4 Length = n

| | | | Appl. | | | | |
|---|---|---|---|---|---|---|---|
| Information | | | Sx | Sx | Sx | | |
| elements | P | Condition/Comment | a | b | c | N4 | IE Type |
| Remote GTP-U | M | This IE shall include the IP address of the remote | X | X | — | X | Remote GTP- |
| Peer | | GTP-U peer which has restarted. | | | | | U Peer |
| | | More than one IE with this type may be included to represent | | | | | |
| | | multiple remote GTP-U peers which are affected by the restart. | | | | | |

### 8.2.69 Node Report Type

The Node Report Type IE shall be encoded as shown in FIG. 8.2.69-1. It indicates the type of the node report the UP function sends to the CP function.

FIG. 8.2.69-1: Node Report Type

| | Bits | | | | | | | |
|---|---|---|---|---|---|---|---|---|
| Octets | 8 | 7 | 6 | 5 | 4 | 3 | 2 | 1 |
| 1 to 2 | Type = 101 (decimal) | | | | | | | |
| 3 to 4 | Length = n | | | | | | | |
| 5 | Spare | Spare | Spare | Spare | GPQR | CKDR | UPRR | UPFR |

| | |
|---|---|
| 6 to (n + 4) | These octet(s) is/are present only if explicitly specified |

Octet 5 shall be encoded as follows:
Bit 1—UPFR (User Plane Path Failure Report): when set to “1”, this indicates a User Plane Path Failure Report.
Bit 2—UPRR (User Plane Path Recovery Report): when set to “1”, this indicates a User Plane Path Recovery Report.
Bit 3—CKDR (Clock Drift Report): when set to “1”, this indicates a Clock Drift Report.
Bit 4—GPQR (GTP-U Path QoS Report): when set to “1”, this indicates a GTP-U Path QoS Report.
Bit 5—PURR (peer GTP-U entity Restart Report): when set to “1”, this indicates a Peer GTP-U Restart report.
Bit 6 to 8—Spare, for future use and set to “0”.

At least one bit shall be set to “1”. Several bits may be set to “1”.
NOTE: If both UPFR and UPRR bits are set to “1”, the Remote GTP-U Peer IEs in the User Plane Path Failure Report IE and in the User Plane Path Recovery Report IE are different.

The CP function and UP function needs to indicate their Support of this new feature (as described above) via CP function feature and UP function feature.

### 8.2.58 CP Function Features

The CP Function Features IE indicates the features supported by the CP function. Only features having an impact on the (system-wide) UP function behaviour are signalled in this IE. It is coded as depicted in FIG. 8.2.58-1.

FIG. 8.2.58-1: CP Function Features

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = 89 (decimal) |
| 3 to 4 | Length = n |
| 5 | Supported-Features |
| 6 to 7 | Additional Supported-Features 1 |
| 8 to (n + 4) | These octet(s) is/are present only if explicitly |
| | specified |

The CP Function Features IE takes the form of a bitmask where each bit set indicates that the corresponding feature is supported. Spare bits shall be ignored by the receiver. The same bitmask is defined for all PFCP interfaces.

The following table specifies the features defined on PFCP interfaces and the interfaces on which they apply.

TABLE 8.2.58-1
CP Function Features

| Feature | | | | |
|---|---|---|---|---|
| Octet/ | | | | |
| Bit | Feature | Interface | M/O | Description |
| 5/1 | LOAD | Sxa, Sxb, Sxc, N4 | O | Load Control is supported by the CP |
| | | | | function. |
| 5/2 | OVRL | Sxa, Sxb, Sxc, N4 | O | Overload Control is supported by the CP |
| | | | | function. |
| * | * | * | * | * |
| 6/x | PSUCC | Sxb, Sxc, N4 | O | CP function supports PFCP session |
| | | | | establishment or modification with Partial |
| | | | | Success, i.e. with UP function reporting |
| | | | | rules that cannot be activated. |
| | | | | See clause 5.2.9. |
| 6/x | RPURR | Sxb, Sxc, N4 | O | CP function supports Receiving the Peer |
| | | | | UP Restart Report. |

### 8.2.25 UP Function Features

The UP Function Features IE indicates the features supported by the UP function. It is coded as depicted in FIG. 8.2.25-1.

FIG. 8.2.25-1: UP Function Features

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = 43 (decimal) |
| 3 to 4 | Length = n |
| 5 to 6 | Supported-Features |
| 7 to 8 | Additional Supported-Features 1 |
| 9 to 10 | Additional Supported-Features 2 |
| 11 to 12 | Additional Supported-Features 3 |
| 13 to (n + 4) | These octet(s) is/are present only if explicitly |
| | specified |

The UP Function Features IE takes the form of a bitmask where each bit set indicates that the corresponding feature is supported. Spare bits shall be ignored by the receiver. The same bitmask is defined for all PFCP interfaces.

The following table specifies the features defined on PFCP interfaces and the interfaces on which they apply.

TABLE 8.2.25-1
UP Function Features

| Feature | | | | |
|---|---|---|---|---|
| Octet/ | | | | |
| Bit | Feature | Interface | M/O | Description |
| 5/1 | BUCP | Sxa, N4 | O (NOTE | Downlink Data Buffering in CP function is |
| | | | 2) | supported by the UP function. |
| 5/2 | DDND | Sxa, N4 | O | The buffering parameter ‘Downlink Data |
| | | | | Notification Delay’ is supported by the UP |
| | | | | function. |
| * | * | * | * | * |
| 11/1 | DRQOS | N4 | O | UP function supports Direct Reporting of |
| | | | | QoS monitoring events to Local NEF or AF |
| | | | | (see clause 5.33.5). |
| 6/x | SPURR | Sxb, Sxc, N4 | O | UP function supports Sending of Peer UP |
| | | | | Restart Report. |

### End of TS 29.244

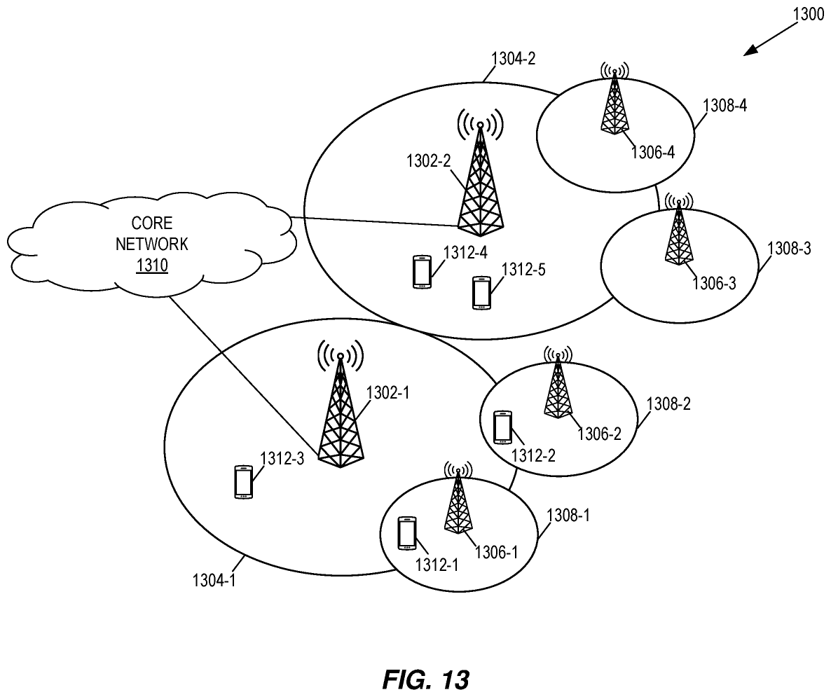

### FIG. 13

FIG. 13 illustrates one example of a cellular communications system 1300 in which embodiments of the present disclosure may be implemented. In the embodiments described herein, the cellular communications system 1300 is a 5G system (5GS) including a Next Generation RAN (NG-RAN) and a 5G Core (5GC). In this example, the RAN includes base stations 1302-1 and 1302-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 1304-1 and 1304-2. The base stations 1302-1 and 1302-2 are generally referred to herein collectively as base stations 1302 and individually as base station 1302. Likewise, the (macro) cells 1304-1 and 1304-2 are generally referred to herein collectively as (macro) cells 1304 and individually as (macro) cell 1304. The RAN may also include a number of low power nodes 1306-1 through 1306-4 controlling corresponding small cells 1308-1 through 1308-4. The low power nodes 1306-1 through 1306-4 can be small base stations (such as pico or femto base stations) or RRHs, or the like. Notably, while not illustrated, one or more of the small cells 1308-1 through 1308-4 may alternatively be provided by the base stations 1302. The low power nodes 1306-1 through 1306-4 are generally referred to herein collectively as low power nodes 1306 and individually as low power node 1306. Likewise, the small cells 1308-1 through 1308-4 are generally referred to herein collectively as small cells 1308 and individually as small cell 1308. The cellular communications system 1300 also includes a core network 1310, which in the 5G System (5GS) is referred to as the 5GC. The base stations 1302 (and optionally the low power nodes 1306) are connected to the core network 1310.

The base stations 1302 and the low power nodes 1306 provide service to wireless communication devices 1312-1 through 1312-5 in the corresponding cells 1304 and 1308. The wireless communication devices 1312-1 through 1312-5 are generally referred to herein collectively as wireless communication devices 1312 and individually as wireless communication device 1312. In the following description, the wireless communication devices 1312 are oftentimes UEs, but the present disclosure is not limited thereto.

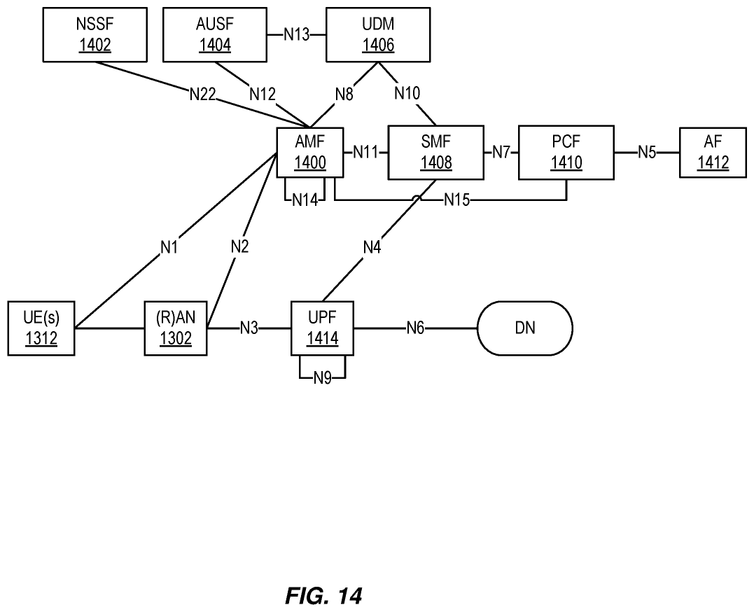

### FIG. 14

FIG. 14 illustrates a wireless communication system represented as a 5G network architecture composed of core Network Functions (NFs), where interaction between any two NFs is represented by a point-to-point reference point/interface. FIG. 14 can be viewed as one particular implementation of the system 1300 of FIG. 13.

Seen from the access side the 5G network architecture shown in FIG. 14 comprises a plurality of UEs 1312 connected to either a RAN 1302 or an Access Network (AN) as well as an AMF 1400. Typically, the R (AN) 1302 comprises base stations, e.g. such as eNBs or gNBs or similar. Seen from the core network side, the 5GC NFs shown in FIG. 14 include a NSSF 1402, an AUSF 1404, a UDM 1406, the AMF 1400, a SMF 1408, a PCF 1410, and an Application Function (AF) 1412.

Reference point representations of the 5G network architecture are used to develop detailed call flows in the normative standardization. The N1 reference point is defined to carry signaling between the UE 1312 and AMF 1400. The reference points for connecting between the AN 1302 and AMF 1400 and between the AN 1302 and UPF 1414 are defined as N2 and N3, respectively. There is a reference point, N11, between the AMF 1400 and SMF 1408, which implies that the SMF 1408 is at least partly controlled by the AMF 1400. N4 is used by the SMF 1408 and UPF 1414 so that the UPF 1414 can be set using the control signal generated by the SMF 1408, and the UPF 1414 can report its state to the SMF 1408. N9 is the reference point for the connection between different UPFs 1414, and N14 is the reference point connecting between different AMFs 1400, respectively. N15 and N7 are defined since the PCF 1410 applies policy to the AMF 1400 and SMF 1408, respectively. N12 is required for the AMF 1400 to perform authentication of the UE 1312. N8 and N10 are defined because the subscription data of the UE 1312 is required for the AMF 1400 and SMF 1408.

The 5GC network aims at separating UP and CP. The UP carries user traffic while the CP carries signaling in the network. In FIG. 14, the UPF 1414 is in the UP and all other NFs, i.e., the AMF 1400, SMF 1408, PCF 1410, AF 1412, NSSF 1402, AUSF 1404, and UDM 1406, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 1400 and SMF 1408 are independent functions in the CP. Separated AMF 1400 and SMF 1408 allow independent evolution and scaling. Other CP functions like the PCF 1410 and AUSF 1404 can be separated as shown in FIG. 14.

Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

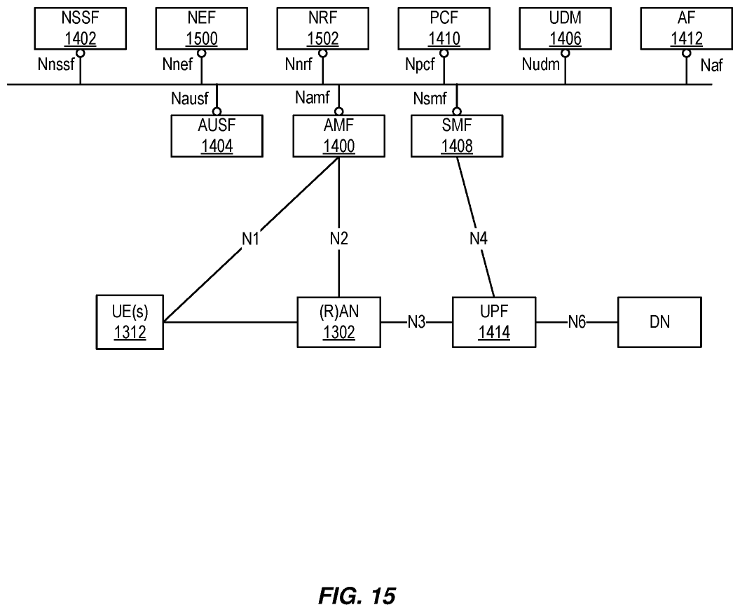

### FIG. 15

FIG. 15 illustrates a 5G network architecture using service-based interfaces between the NFs in the CP, instead of the point-to-point reference points/interfaces used in the 5G network architecture of FIG. 14. However, the NFs described above with reference to FIG. 14 correspond to the NFs shown in FIG. 15. The service(s) etc. that a

NF provides to other authorized NFs can be exposed to the authorized NFs through the service-based interface. In FIG. 15 the service based interfaces are indicated by the letter “N” followed by the name of the NF, e.g. Namf for the service based interface of the AMF 1400 and Nsmf for the service based interface of the SMF 1408, etc. The NEF 1500 and the NRF 1502 in FIG. 15 are not shown in FIG. 14 discussed above. However, it should be clarified that all NFs depicted in FIG. 14 can interact with the NEF 1500 and the NRF 1502 of FIG. 15 as necessary, though not explicitly indicated in FIG. 14.

Some properties of the NFs shown in FIGS. 14 and 15 may be described in the following manner. The AMF 1400 provides UE-based authentication, authorization, mobility management, etc. A UE 1312 even using multiple access technologies is basically connected to a single AMF 1400 because the AMF 1400 is independent of the access technologies. The SMF 1408 is responsible for session management and allocates Internet Protocol (IP) addresses to UEs. It also selects and controls the UPF 1414 for data transfer. If a UE 1312 has multiple sessions, different SMFs 1408 may be allocated to each session to manage them individually and possibly provide different functionalities per session. The AF 1412 provides information on the packet flow to the PCF 1410 responsible for policy control in order to support QoS. Based on the information, the PCF 1410 determines policies about mobility and session management to make the AMF 1400 and SMF 1408 operate properly. The AUSF 1404 supports authentication function for UEs or similar and thus stores data for authentication of UEs or similar while the UDM 1406 stores subscription data of the UE 1312. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

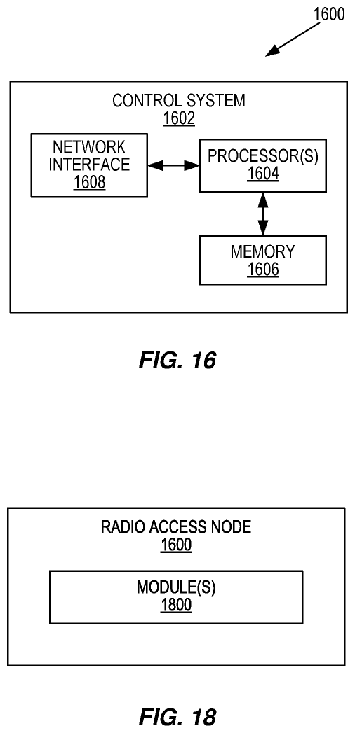

### FIG. 16

FIG. 16 is a schematic block diagram of a network node 1600 according to some embodiments of the present disclosure. Optional features are represented by dashed boxes. The network node 1600 may be, for example, a core network node that implements a NF (e.g., AMF 1400, SMF 1408, or NSACF 1504) or a network node that implements all or part of the functionality of an NF (e.g., all or part of the functionality of the AMF 1400, the SMF 1408, or the NSACF 1504 described herein). As illustrated, the network node 1600 includes a one or more processors 1604 (e.g., Central Processing Units (CPUs), Application Specific Integrated Circuits (ASICs), Field Programmable Gate Arrays (FPGAs), and/or the like), memory 1606, and a network interface 1608. The one or more processors 1604 are also referred to herein as processing circuitry. The one or more processors 1604 operate to provide one or more functions of the network node 1600 as described herein (e.g., one or more functions of the AMF 1400, the SMF 1408, or the NSACF 1504 described herein). In some embodiments, the function(s) are implemented in software that is stored, e.g., in the memory 1606 and executed by the one or more processors 1604. Examples of the network node 1600 may include the CP-1 800, the UP-1 802, and the UP-2 804 in FIG. 8.

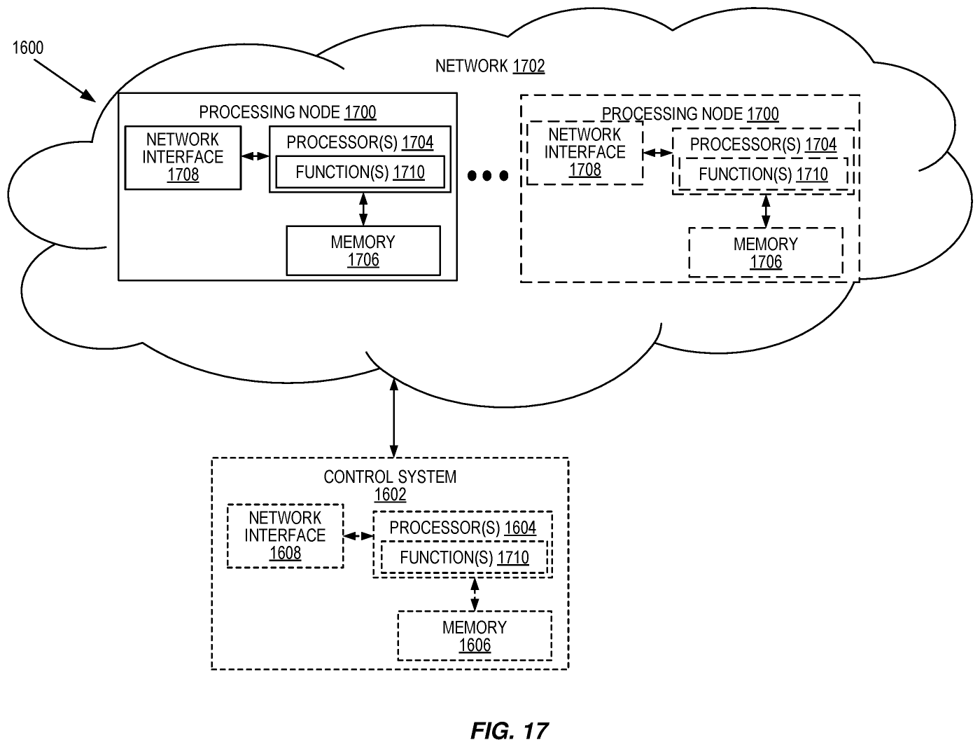

### FIG. 17

FIG. 17 is a schematic block diagram that illustrates a virtualized embodiment of the network node 1600 according to some embodiments of the present disclosure. Again, optional features are represented by dashed boxes. As used herein, a “virtualized” network node is an implementation of the network node 1600 in which at least a portion of the functionality of the network node 1600 is implemented as a virtual component(s) (e.g., via a virtual machine(s) executing on a physical processing node(s) in a network(s)). As illustrated, in this example, the network node 1600 includes one or more processing nodes 1700 coupled to or included as part of a network(s) 1702. Each processing node 1700 includes one or more processors 1704 (e.g., CPUs, ASICs, FPGAs, and/or the like), memory 1706, and a network interface 1708. In this example, functions 1710 of the network node 1600 described herein (e.g., one or more functions of the AMF 1400, the SMF 1408, or the NSACF 1504 described herein) are implemented at the one or more processing nodes 1700 or distributed across the two or more processing nodes 1700 in any desired manner. In some particular embodiments, some or all of the functions 1710 of the network node 1600 described herein are implemented as virtual components executed by one or more virtual machines implemented in a virtual environment(s) hosted by the processing node(s) 1700.

In some embodiments, a computer program including instructions which, when executed by at least one processor, causes the at least one processor to carry out the functionality of the network node 1600 or a node (e.g., a processing node 1700) implementing one or more of the functions 1710 of the network node 1600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 18

FIG. 18 is a schematic block diagram of the network node 1600 according to some other embodiments of the present disclosure. The network node 1600 includes one or more modules 1800, each of which is implemented in software. The module(s) 1800 provide the functionality of the network node 1600 described herein. This discussion is equally applicable to the processing node 1700 of FIG. 17 where the modules 1800 may be implemented at one of the processing nodes 1700 or distributed across multiple processing nodes 1700.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### Summary of Some Embodiments

Some of the embodiments described above may be summarized in the following manner:
1. A method performed by a Control Plane function, CP-1, (800), in a telecommunication network (1302) to manage a restart of a User Plane, UP, function in a user plane path for Protocol Data Unit, PDU, sessions that the CP-1 (800) is managing, the method comprises:
   receiving (FIG. 9, 900) a Packet Forwarding Control Protocol, PFCP, message from the UP function, UP-1, (802) comprising a report related to another UP function, UP-2, (804) has restarted;
   acknowledging (FIG. 9, 902) the report; and
   performing (FIG. 9, 904) an action based on an identity of the other UP-2 (804).
2. The method of embodiment 1 wherein the identity of the UP-2 (804) is a Radio Access Node, RAN, or a New Generation, NG-RAN node and the action is restoring (FIG. 9, 904A) user plane connection for affected PDU sessions.
3. The method of embodiment 1 wherein the identity of the UP-2 (804) is a PSA UDF or a PGW-U and the action is releasing (FIG. 9, 904B) affected PDU sessions.
4. The method of any of embodiments 1 to 3 wherein the PFCP message is a PFCP Node Report Request message.
5. The method of any of embodiments 1 to 4 wherein the report comprises an indication that the UP-1 (802) has removed a remote F-TEID allocated by the UP-2 (804) and changed apply-action in FAR to buffering for affected PFCP sessions.
6. The method of any of embodiments 1 to 5 wherein the CP-1 (800) is implemented in one or more of (a) Serving Gateway Control plane function, SGW-C, (b) Packet Data Network, PDN, Gateway Control plane function, PGW-C, and (c) Session Management Function, SMF.
7. A method performed by a first User Plane function, UP-1, (802) communicating with a Control Plane function, CP-1, (800) and a second User Plane function, UP-2, (804) in a telecommunication network (1302) for managing a peer UP function restart, the method comprising:
   sending (FIG. 10, 1000) an Echo Request to the UP-2 (804);
   receiving (FIG. 10, 1002) an Echo Response from the UP-2 (804);
   receiving (FIG. 10, 1004) an Echo Request from the UP-2 (804);
   sending (FIG. 10, 1006) an Echo response to the UP-2 (804);
   receiving (FIG. 10, 1008) an GTP error indication containing a recovery timestamp;
   comparing (FIG. 10, 1010) the recovery timestamp received in the GTP error indication with a recovery timestamp previously received via the Echo Request, the Echo Response or the GTP error indication;
   determining (FIG. 10, 1012) that the UP-2 (804) has restarted;
   stopping (FIG. 10, 1014) sending a further payload to the restarted UP-2 (804);
   removing (FIG. 10, 1016) the F-TEID allocated by the UP-2 (804) and change apply-action to Buffering;
   sending (FIG. 10, 1018) a PFCP request message to report the restart of the UP-2 (804); and
   receiving (FIG. 10, 1020) a PFCP response message.
8. The method of embodiment 7 wherein the Echo Request sent by the UP-1 (802) comprises a recovery timestamp.
9. The method of any of embodiment 7 or 8 wherein the UP-1 (802) is implemented in one or more of (a) New Radio, NR, Node B, gNB, (b) evolved Node B, eNB, (c) Serving Gateway Control plane function, SGW-U, (d) Packet Data Network, PDN, Gateway Control plane function, PGW-U, (e) Intermediate User Plane Function, I-UPF, (f) Visiting User Plane Function, V-UPF, and (g) Protocol Data Unit, PDU, Session Anchor, PSA UPF.
10. The method of any of embodiments 7 to 9 wherein the Echo Request sent by the UP-1 (802) comprises Recovery Information of the UP-1 (802), which is identified by a source IP address of the Echo Request sent by the UP-1 (802).
11. The method of any of embodiments 7 to 10 wherein the Echo Response received by the UP-1 (802) comprises Recovery Information of the UP-2 (804), which is identified by a resource IP address of the Echo Response received by the UP-1 (802).
12. The method of any of embodiments 7 to 11 wherein the PFCP request message is a PFCP Node Report Request message.
13. The method of embodiment 12 wherein the PFCP Node Report Request message indicates that the UP-2 (804) has restarted and GTP-U context associated with a list of IP addresses have been lost.
14. The method of embodiment 12 wherein the PFCP Node Report Response message comprises an acknowledgment that Downlink FAR in all affected PFCP sessions has been updated with apply-action set to buffering and remote F-TEID is removed.
15. A method performed by a second User Plane function, UP-2, (804) communicating with a Control Plane function, CP-1, (800) and a first User Plane function, UP-1, (802) in a telecommunication network (1302) for managing a restart of a UP function, the method comprising:
   sending (FIG. 11, 1100) an Echo Request to the UP-1 (802);
   receiving (FIG. 11, 1102) an Echo Response from the UP-1 (802);
   receiving (FIG. 11, 1104) an Echo Request from the UP-1 (802);
   sending (FIG. 11, 1106) an Echo response to the UP-1 (802); and
   sending (FIG. 11, 1108) an GTP error indication comprising a new recovery timestamp.
16. The method of embodiment 15 wherein the Echo Request sent by the UP-2 (804) comprises a recovery timestamp.
17. The method of any of embodiment 15 or 16 wherein the UP-2 (804) is implemented in one or more of (a) New Radio, NR, Node B, gNB, (b) evolved Node B, eNB, (c) Serving Gateway Control plane function, SGW-U, (d) Packet Data Network, PDN, Gateway Control plane function, PGW-U, (e) Intermediate User Plane Function, I-UPF, (f) Visiting User Plane Function, V-UPF, and (g) Protocol Data Unit, PDU, Session Anchor, PSA UPF.
18. A network node (1308) implementing a Control Plane function, CP-1, (800), adapted to:
   receive (FIG. 9, 900) a Packet Forwarding Control Protocol, PFCP, message from the UP-1 (802) comprising a report related to the UP-2 (804) has restarted;
   acknowledge (FIG. 9, 902) the report; and
   perform (FIG. 9, 904) an action based on an identity of the UP-2 (804).
19. The network node (1600) implementing the CP-1 (800) of embodiment 18 wherein the network node (1600) is further adapted to perform the method of any of embodiments 2 to 6.
20. A network node (1600) implementing a Control Plane function, CP-1, (800), comprising processing circuitry configured to cause the network node (1600) to:
   send receive (FIG. 9, 900) a Packet Forwarding Control Protocol, PFCP, message from the UP-1 (802) comprising a report related to the UP-2 (804) has restarted;
   acknowledge (FIG. 9, 902) the report; and
   perform (FIG. 9, 904) an action based on an identity of the UP-2 (804).
21. The network node (1600) implementing the CP-1 (800) of embodiment 20 wherein the processing circuitry is further configured to cause the network node (1600) to perform the method of any of embodiments 2 to 6.
22. A network node (1600) implementing a first User Plane Function, UP-1, (802), adapted to:
   send (FIG. 10, 1000) an Echo Request to the UP-2 (804);
   receive (FIG. 10, 1002) an Echo Response from the UP-2 (804);
   receive (FIG. 10, 1004) an Echo Request from the UP-2 (804);
   send (FIG. 10, 1006) an Echo response to the UP-2 (804);
   receive (FIG. 10, 1008) an GTP error indication containing a recovery timestamp;
   compare (FIG. 10, 1010) the recovery timestamp received in the GTP error indication with a recovery timestamp previously received via the Echo Request, the Echo Response or the GTP error indication;
   determine (FIG. 10, 1012) that the UP-2 (804) has restarted;
   stop (FIG. 10, 1014) sending a further payload to the restarted UP-2 (804);
   remove (FIG. 10, 1016) the F-TEID allocated by the UP-2 (804) and change apply-action to Buffering;
   send (FIG. 10, 1018) a PFCP request message to report the restart of 2nd UP function; and
   receive (FIG. 10, 1020) a PFCP response message.
23. The network node (1600) implementing the UP-1 (802) of embodiment 22 wherein the network node (1600) is further adapted to perform the method of any of embodiments 8 to 14.
24. A network node (1600) implementing a first User Plane Function, UP-1, (802), comprising processing circuitry configured to cause the network node (1600) to:
   send (FIG. 10, 1000) an Echo Request to the UP-2 (804);
   receive (FIG. 10, 1002) an Echo Response from the UP-2 (804);
   receive (FIG. 10, 1004) an Echo Request from the UP-2 (804);
   send (FIG. 10, 1006) an Echo Response to the UP-2 (804);
   receive (FIG. 10, 1008) an GTP error indication containing a recovery timestamp;
   compare (FIG. 10, 1010) the recovery timestamp received in the GTP error indication with a recovery timestamp previously received via the Echo Request, the Echo Response or the GTP error indication;
   determine (FIG. 10, 1012) that the UP-2 (804) has restarted;
   stop (FIG. 10, 1014) sending a further payload to the restarted UP-2 (804);
   remove (FIG. 10, 1016) the F-TEID allocated by the UP-2 (804) and change apply-action to Buffering;
   send (FIG. 10, 1018) a PFCP request message to report the restart of 2nd UP function; and
   receive (FIG. 10, 1020) a PFCP response message.
25. The network node (1600) implementing the UP-1 (802) of embodiment 24 wherein the processing circuitry is further configured to cause the network node (1600) to perform the method of any of embodiments 8 to 14.
26. A network node (1600) implementing a second User Plane Function, UP-2, (804), adapted to:
   send (FIG. 11, 1100) an Echo Request to the UP-1 (802);
   receive (FIG. 11, 1102) an Echo Response from the UP-1 (802);
   receive (FIG. 11, 1104) an Echo Request from the UP-1 (802);
   send (FIG. 11, 1106) an Echo response to the UP-1 (802); and
   send (FIG. 11, 1108) an GTP error indication comprising a new recovery timestamp.
27. The network node (1600) implementing the UP-2 (804) of embodiment 26 wherein the network node (1600) is further adapted to perform the method of embodiment 16 or 17.
28. A network node (1600) implementing a second User Plane Function, UP-2, (804), comprising processing circuitry configured to cause the network node (1600) to:
   send (FIG. 11, 1100) an Echo Request to the UP-1 (802);
   receive (FIG. 11, 1102) an Echo Response from the UP-1 (802);
   receive (FIG. 11, 1104) an Echo Request from the UP-1 (802);
   send (FIG. 11, 1106) an Echo response to the UP-1 (802); and
   send (FIG. 11, 1108) an GTP error indication comprising a new recovery timestamp.
29. The network node (1600) implementing the UP-2 (804) of embodiment 28 wherein the processing circuitry is further configured to cause the network node (1600) to perform the method of embodiment 27 or 28.
30. A method performed by a Control Plane function, CP-1, (800), a first User Plane function, UP-1, (802), and a second User Plane function, UP-2, (804) in a telecommunication network (1302) for managing a peer UP function restart, the method comprising: the method comprising:
   at the CP-1 (800):
      receiving (FIG. 12, 1208) a Packet Forwarding Control Protocol, PFCP, request message from the UP-1 (802) comprising a report related to the UP-2 (804) has restarted;
      acknowledging (FIG. 12, 1210) the report by sending a PFCP response message; and
      performing (FIG. 12, 1212) an action based on an identity of the UP-2 (804).
   at the UP-1 (802):
      sending (FIG. 12, 1200) an Echo Request to the UP-2 (804);
      receiving (FIG. 12, 1200) an Echo Response from the UP-2 (804);
      receiving (FIG. 12, 1202) an Echo Request from the UP-2 (804);
      sending (FIG. 12, 1202) an Echo Response to the UP-2 (804);
      receiving (FIG. 12, 1204) an GTP error indication containing a recovery timestamp;
      comparing (FIG. 12, 1206A) the recovery timestamp received in the GTP error indication with a recovery timestamp previously received via the Echo Request, the Echo Response or the GTP error indication;
      determining (FIG. 12, 1206B) that the UP-2 (804) has restarted;
      stopping (FIG. 12, 1206C) sending a further payload to the restarted UP-2 (804);
      removing (FIG. 12, 1206D) the F-TEID allocated by the UP-2 (804) and change apply-action to Buffering;
      sending (FIG. 12, 1208) the PFCP request message to report the restart of the UP-2 (804); and
      receiving (FIG. 12, 1210) the PFCP response message.
   at the UP-2 (804):
      sending (FIG. 12, 1202) an Echo Request to the UP-1 (802);
      receiving (FIG. 12, 1202) an Echo Response from the UP-1 (802);
      receiving (FIG. 12, 1200) an Echo Request from the UP-1 (802);
      sending (FIG. 12, 1200) an Echo response to the UP-1 (802); and
      sending (FIG. 12, 1204) an GTP error indication comprising a new recovery timestamp.
31. The method of embodiment 30 wherein the identity of the UP-2 (804) is a Radio Access Node, RAN, or a New Generation, NG-RAN node and the action is restoring (FIG. 9, 904A) user plane connection for affected PDU sessions.
32. The method of embodiment 30 wherein the identity of the UP-2 (804) is a PSA UDF or a PGW-U and the action is releasing (FIG. 9, 904B) affected PDU sessions.
33. A method performed by a Control Plane function, CP-1, (800), a first User Plane function, UP-1, (802), and a second User Plane function, UP-2, (804) in a telecommunication network (1302) for detecting a restart of the UP-2 (804) and reporting the restart to the CP-1 (800) to restore a user plane path, the method comprising:
   at the UP-2 (804):
      sending (FIG. 8, 814) a General Packet Radio Service Tunnelling Protocol, GTP Error Indication message to the UP-1 (802) after the restart of the UP-2 (804);
   at the UP-1 (802):
      sending (FIG. 8, 816) a PFCP Node Report Request message to the CP-1 (800); and
   at the CP-1 (800):
      releasing (FIG. 8, 820) Protocol Data Unit, PDU, sessions affected by the restart of the UP-2 (804) after receiving the PFCP Node Report Request message from the UP-1 (802).
34. The method of embodiment 33 further comprising:
   at the UP-1 (802):
      sending (FIG. 8, 810) an Echo Request to the UP-2 (804);
      receiving (FIG. 8, 810) an Echo Response from the UP-2 (804);
      receiving (FIG. 8, 814) the GTP Error Indication message;
   at the UP-2 (804):
      sending (FIG. 8, 812) an Echo Request to the UP-1 (802);
      receiving (FIG. 8, 812) an Echo Response from the UP-1 (802); and
   at the UP-1 (802):
      receiving (FIG. 8, 818) a PFCP Node Report Response message from the CP-1 (800).
35. The method of embodiment 34 wherein the Echo Request sent by the UP-1 (802) comprises Recovery Information of the UP-1 (802), which is identified by a source IP address of the Echo Request sent by the UP-1 (802).
36. The method of embodiment 34 wherein the Echo Response received by the UP-1 (802) comprises Recovery Information of the UP-2 (804), which is identified by a resource IP address of the Echo Response received by the UP-1 (802).
37. The method of any of embodiments 33 to 36 wherein the CP-1 (800) is implemented in one or more of (a) Serving Gateway Control plane function, SGW-C, (b) Packet Data Network, PDN, Gateway Control plane function, PGW-C, and (c) Session Management Function, SMF.
38. The method of any of embodiments 33 to 37 wherein the UP-1 (802) is implemented in one or more of (a) New Radio, NR, Node B, gNB, (b) evolved Node B, eNB, (c) Serving Gateway Control plane function, SGW-U, (d) Packet Data Network, PDN, Gateway Control plane function, PGW-U, (e) Intermediate User Plane Function, I-UPF, (f) Visiting User Plane Function, V-UPF, and (g) Protocol Data Unit, PDU, Session Anchor, PSA UPF.
39. The method of any of embodiments 33 to 38 wherein the UP-2 (804) is implemented in one or more of (a) New Radio, NR, Node B, gNB, (b) evolved Node B, eNB, (c) Serving Gateway Control plane function, SGW-U, (d) Packet Data Network, PDN, Gateway Control plane function, PGW-U, (e) Intermediate User Plane Function, I-UPF and (f) Visiting User Plane Function, V-UPF, and (g) Protocol Data Unit, PDU, Session Anchor, PSA UPF.
40. The method of any of embodiments 33 to 39 wherein the GTP Error Indication message comprises a Recovery Information.
41. The method of any of embodiments 40 wherein the GTP Error Indication message further comprises a list of IP address affected by the restart of the UP-2 (804).
42. The method of any of embodiments 33 to 41 wherein the PFCP Node Report Request message indicates that the UP-2 (804) has restarted and GTP-U context associated with a list of IP addresses have been lost.
43. The method of any of embodiments 33 to 41 wherein the PFCP Node Report Response message comprises an acknowledgment that Downlink FAR in all affected PFCP sessions has been updated with apply-action set to buffering and remote F-TEID is removed.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
2G Second Generation
3G Third Generation
3GPP Third Generation Partnership Project
4G Fourth Generation
5G Fifth Generation
5GS Fifth Generation System
6G Sixth Generation
AMF Access and Mobility Management Function
AP Access Point
BS Base Station
BSC Base Station Controller
BTS Base Transceiver Station
DL Downlink
eNB evolved Node B
E-UTRA Evolved Universal Terrestrial Radio Access
E-UTRAN Evolved Universal Mobile Telecommunications System Terrestrial Radio Access Network
F-TEID Fully qualified Tunnel Endpoint Identifier
gNB NR Node B
GPRS General Packet Radio Service
GSM Global System for Mobile Communications
GTP General Packet Radio Service Tunnelling Protocol
HSS Home Subscriber Server
IoT Internet of Things
I-UPF Intermediate User Plane Function
LTE Long Term Evolution
MME Mobility Management Entity
MSC Mobile Switching Center
MTC Machine Type Communication
NEF Network Exposure Function
NFV Network Function Virtualization
NR New Radio
O&M Operation and Maintenance
OSS Operations Support System
OTT Over-The-Top
PDN Packet Data Network
PDU Protocol Data Unit
PFCP Packet Forwarding Control Protocol
PGW Packet Gateway
PGW-C Packet Data Network (PDN) Gateway Control plane function
PLMN Public Land Mobile Network
RAN Radio Access Network
RAT Radio Access Technology
RNC Radio Network Controller
SGW Serving Gateway
SGW-C
Serving Gateway Control plane function
Session Management Function
SMF
TCP/IP
UE
Transmission Control Protocol/Internet Protocol
User Equipment
UL Uplink
UMTS Universal Mobile Telecommunications System
UPF User Plane Function
USIM Universal Subscriber Identity Module
WCDMA Wideband Code Division Multiplexing Access
WLAN Wide Local Area Network

Conclusion 3: A restarted GTP-U entity, if its GTP-U contexts can't be restored, e.g. by the control plane, will send massive amount of GTP Error Indication messages for the unknown incoming GTP-U packets to the peer User Plane function sending those GTP-U packets; and receiving those GTP Error Indication message leads further massive signalling over Sx/N4 interface. Such massive signalling over GTP-U interface and Sx/N4 interface should be avoided.

### 3. Proposal

It is proposed to introduce detection of a GTP-U entity restart over GTP-U interface and report such GTP-U entity restart using PFCP Node Report procedure, like GTP-U path failure reporting, to avoid PFCP Session Modification procedure.

C4-216xyz starts with a stage 2 CR describing detection of a GTP-U entity restart.

1-43. (canceled)

44. A method performed by a Control Plane function, CP, function, in a telecommunication network to manage a restart of a second User Plane, UP, function in a user plane path for Protocol Data Unit, PDU, sessions that the CP function is managing, the method comprises:
receiving a Packet Forwarding Control Protocol, PFCP, Node Report Request message from a first UP function comprising a report related to a restart of the second UP function, where the PFCP Node Report request message indicates:
(1) that the second UP function has restarted and GTP-U context associated with the list of IP addresses have been lost; and
(2) that the CP function needs not to send a PFCP Session Modification Request message to change DL FAR per a PFCP session;
sending, as a response to the PFCP Node Report Request message, a PFCP Node report Response message that comprises an acknowledgment that the Downlink FAR in all affected PFCP sessions associated with the restarted second UP function has been updated with apply-action set to buffering, and remote F-TEID from the second UP function has been removed; and
releasing PDU sessions affected by the remote GTP-U restart based on a local configuration.

45. A method performed by a first User Plane, UP, function communicating with a Control Plane, CP, function and a second UP function in a telecommunication network for managing a restart of the second UP function, the method comprising:
receiving an GTP error indication containing a recovery timestamp and list of IP addresses affected by a restart of the second UP function to indicate that all GTP-U context associated with these IP addresses have been lost;
sending a Packet Forwarding Control Protocol, PFCP, Node Report request message to a Control Plane, CP, function to report the restart of the second UP function, where the PFCP Node Report request message indicates:
(1) that the second UP function has restarted and GTP-U context associated with the list of IP addresses have been lost; and
(2) that the CP function needs not to send a PFCP Session Modification Request message to change DL FAR per a PFCP session; and
receiving a PFCP Node Report response message.

46. The method of claim 45 wherein the UP-1 is implemented in one or more of (a) New Radio, NR, Node B, gNB, (b) evolved Node B, eNB, (c) Serving Gateway Control plane function, SGW-U, (d) Packet Data Network, PDN, Gateway Control plane function, PGW-U, (e) Intermediate User Plane Function, I-UPF, (f) Visiting User Plane Function, V-UPF, and (g) Protocol Data Unit, PDU, Session Anchor, PSA UPF.

47. The method of claim 45 wherein the PFCP Node Report Response message comprises an acknowledgment that Downlink FAR in all affected PFCP sessions has been updated with apply-action set to buffering and remote F-TEID is removed.
